(19) United States
(12) Patent Application Publication
(10) Pub. No.: US 2019/0387116 A1
(43) Pub. Date: Dec. 19, 2019

(54) IMAGE FORMING APPARATUS, IMAGE FORMING SYSTEM, AND METHOD OF CONTROLLING DISPLAY

(71) Applicant: SHARP KABUSHIKI KAISHA, Sakai City (JP)

(72) Inventor: MASAHIRO SAKIYAMA, Sakai City (JP)

(21) Appl. No.: 16/439,123

(22) Filed: Jun. 12, 2019

(30) Foreign Application Priority Data
Jun. 15, 2018 (JP) 2018-114207

(51) Int. Cl. H04N 1/00

(52) U.S. Cl. CPC H04N 1/00514; H04N 1/0097

(57) ABSTRACT

Provided is an image forming apparatus that displays a feature not used by a user on the basis of a usage history of the user. The image forming apparatus includes a display unit; a history-information storage unit that stores history information indicating a history of features that have been used in the image forming apparatus; a feature extracting unit that extracts, from first history information corresponding to history information of a current user operating the image forming apparatus and second history information different from the first history information, a feature included in the second history information and not included in the first history information; and a display control unit that controls the display unit to display the extracted feature.

### BACKGROUND OF THE INVENTION

### Field of the Invention

The present invention relates to an image forming apparatus and the like.

### Description of the Background Art

Today, image forming apparatuses, such as digital multifunction peripherals, have a very large number of features. Thus, it is difficult for users to understand and use all features of an image forming apparatus. In particular, infrequently used features are typically listed in a deep level menu. Thus, such an infrequently used feature is more or less hidden from the user and is not readily accessed even if the feature allows the user to efficiently perform an intended operation. Hence, there is a proposed technique of presenting features of an image forming apparatus to users such that the users can recognize the features.

For example, there is a disclosed technique of storing history information on features of an image forming apparatus and presenting features that have been used by the user not more than a predetermined number of times (for example, refer to Japanese Unexamined Patent Publication No. 2007-168156).

### SUMMARY OF THE INVENTION

However, if the presentation of a feature is based on the number of times the feature has been used by the user, all infrequently used features will be presented to the user even if such infrequently used features include a specific feature intentionally unused by the user. Presenting such an intentionally unused feature to the user provides no useful information and does not lead to improved convenience.

An object of the present invention, which has been conceived in light of the issue described above, is to provide an image forming apparatus that displays a feature not used by a user on the basis of a usage history of the user.

To solve such an issue as described above, the image forming apparatus according to the present invention includes a history-information storage unit that stores history information indicating a history of features that have been used in the image forming apparatus; a feature extracting unit that extracts, from first history information corresponding to history information of a current user operating the image forming apparatus and second history information different from the first history information, a feature included in the second history information and not included in the first history information; and a display control unit that controls the display unit to display the extracted feature.

An image forming system according to the present invention includes a plurality of image forming apparatuses; and a history-information managing apparatus that manages history information indicating a history of features that have been used in the image forming apparatuses, the history-information managing apparatus including a history-information managing unit that correlates and manages environment information indicating an environment in which the image forming apparatuses are used and history information of the image forming apparatuses, the environment information and the history information being acquired from the image forming apparatuses, each of the image forming apparatuses including a display unit; a history-information storage unit that stores history information indicating a history of features that have been used in the image forming apparatus; a history-information acquiring unit that acquires, from the history-information managing apparatus, history information correlated with environment information substantially identical to the environment information of the image forming apparatus; a feature extracting unit that extracts, from first history information corresponding to history information of a current user operating the image forming apparatus and second history information acquired by the history-information acquiring unit, a feature included in the second history information and not included in the first history information; and a display control unit that controls the display unit to display the extracted feature.

An image forming apparatus according to the present invention includes a display unit; a history-information storage unit that stores history information indicating a history of features that have been executed under instructions of a user; a feature extracting unit that extracts a feature related to the features from features of the image forming apparatus; and a display control unit that controls the display unit to display the extracted feature.

A method of controlling display of an image forming apparatus including a display unit according to the present invention, includes storing history information indicating a history of features that have been used in the image forming apparatus; extracting, from first history information corresponding to history information of a current user operating the image forming apparatus and second history information different from the first history information, a feature included in the second history information and not included in the first history information; and controlling the display unit to display the extracted feature.

A method of controlling display of an image forming apparatus including a display unit according to the present invention, includes storing history information indicating a history of features that have been executed under instructions of a user; extracting a feature related to the features from features of the image forming apparatus; and controlling the display unit to display the extracted feature.

With the image forming apparatus according to the present invention, a feature included in second history information and not included in first history information can be displayed on the display unit, the first history information corresponding to history information of a current user operating the image forming apparatus, the second history information being different from the first history information. In this way, the user operating the image forming apparatus according to the present invention can learn a feature used by other users by viewing the feature displayed on the display unit.

Since the features used by users operating the same image forming apparatus are presumed to be similar, the image forming apparatus can present features to the current user as useful information.

### BRIEF DESCRIPTION OF THE DRAWINGS

FIG. 1 illustrates the functional configuration of an image forming apparatus according to a first embodiment;

FIG. 2 illustrates the functional configuration of the image forming apparatus according to the first embodiment;

FIG. 3 illustrates an example data configuration of user information according to the first embodiment;

FIG. 4 illustrates an example data configuration of history information according to the first embodiment;

FIG. 5 illustrates an example data configuration of presented-feature history information according to the first embodiment;

FIG. 6 illustrates an example data configuration of the presented-feature history information according to the first embodiment;

FIG. 7 is a flowchart illustrating the main process of the image forming apparatus according to the first embodiment;

FIG. 8 is a flowchart illustrating the main process of the image forming apparatus according to the first embodiment;

FIG. 9 illustrates an operation example according to the first embodiment;

FIG. 10 illustrates the overall configuration of an image forming system according to a second embodiment;

FIG. 11 is a flowchart illustrating the main process of the image forming apparatus according to the second embodiment;

FIG. 12 illustrates the overall configuration of an image forming system according to a third embodiment;

FIG. 13 illustrates a functional configuration of a history-information managing server in the third embodiment;

FIG. 14 illustrates an example data configuration of apparatus history information according to the third embodiment;

FIG. 15 illustrates an example data configuration of apparatus environment information according to the third embodiment;

FIG. 16 is a flowchart illustrating the main process of a history-information managing apparatus according to the third embodiment;

FIG. 17 is a flowchart illustrating the main process of the image forming apparatus according to the third embodiment;

FIG. 18 illustrates the functional configuration of the image forming apparatus according to a fifth embodiment;

FIG. 19 illustrates an example data configuration of corresponding feature information according to the fifth embodiment; and

FIG. 20 is a flowchart illustrating the main process of the image forming apparatus according to the fifth embodiment.

### DESCRIPTION OF THE PREFERRED EMBODIMENTS

Embodiments of the present invention will now be described with reference to the accompanying drawings. Note that, in the embodiments, an image forming apparatus to which the present invention is applied is described as an example.

### 1. First Embodiment

### 1.1 Functional Configuration

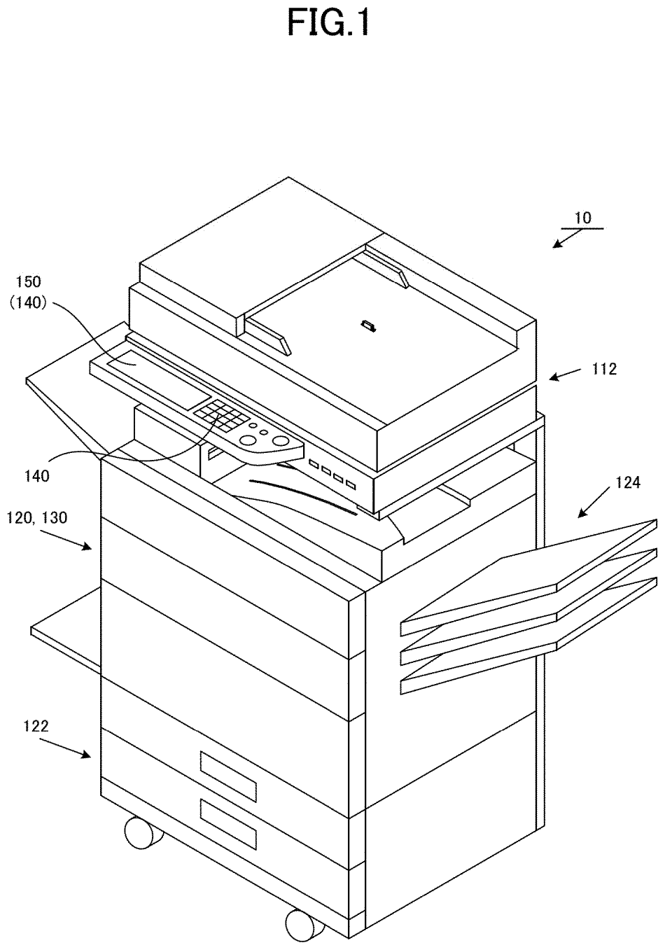

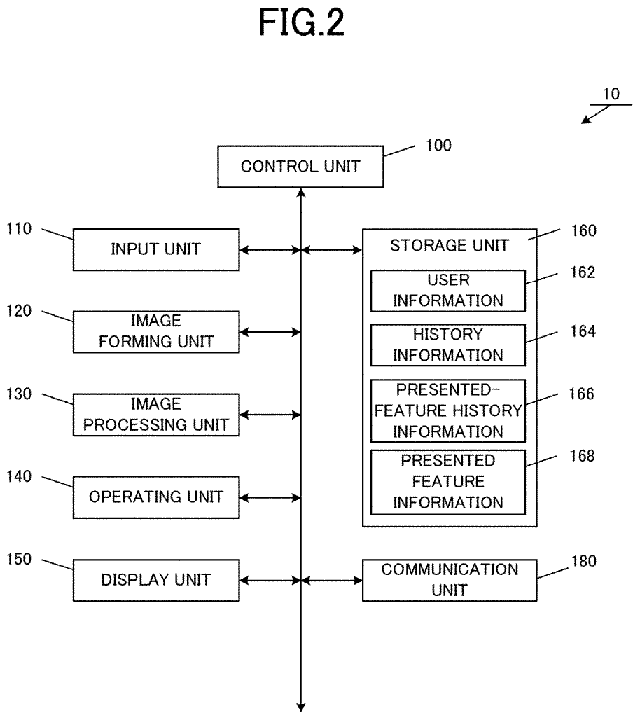

The functional configuration of an image forming apparatus 10 according to the first embodiment of the present embodiment will now be described with reference to FIGS. 1 and 2. FIG. 1 is an external perspective view of the image forming apparatus 10, and FIG. 2 is a functional configuration diagram of the image forming apparatus 10.

With reference to FIG. 2, the image forming apparatus 10 includes a control unit 100, an input unit 110, an image forming unit 120, an image processing unit 130, an operating unit 140, a display unit 150, a storage unit 160, and a communication unit 180.

The control unit 100 is a functional unit for comprehensive control of the image forming apparatus 10. The control unit 100 provides various features by retrieving and executing various programs and includes, for example, at least one computing device (such as a central processing unit (CPU)).

The input unit 110 is a functional unit for reading a document input to the image forming apparatus 10 and generating image data. The input unit 110 is connected to a document reader 112, which is a functional unit for reading an image of a document, and receives image data from the document reader 112. Alternatively, the input unit 110 may receive image data based on data sent from another terminal via the communication unit 180 described below. Alternatively, the input unit 110 may receive image data from a storage medium, such as a universal serial bus (USB) memory or an SD card.

The image forming unit 120 is a functional unit for forming an image of the output image data on a recording medium (for example, a recording sheet). For example, a recording sheet is fed from a feeder tray 122 illustrated in FIG. 1; an image is formed on the surface of the recording sheet at the image forming unit 120; and the recording sheet is ejected on a paper output tray 124. The image forming unit 120 includes, for example, an electrophotographic laser printer.

The image processing unit 130 is a functional unit for executing various types of image processing on image data. For example, the image processing unit 130 performs sharpening on image data sent from the input unit 110.

The operating unit 140 is a functional unit for receiving instructions from the user and includes various key switches and a device for detecting a touch input. The user sets the feature for use via the operating unit 140. The display unit 150 is a functional unit for notifying the user of various types of information and includes, for example, a liquid crystal display (LCD). The image forming apparatus 10 may alternatively include a touch panel integrating the operating unit 140 and the display unit 150. In such a case, a scheme for detecting an input on the touch panel may be any typical detection scheme, such as a resistive film, infrared, electromagnetic induction, or capacitance scheme.

The storage unit 160 is a functional unit for storing various programs and datasets necessary for the operation of the image forming apparatus 10. The storage unit 160 includes, for example, a solid-state drive (SSD) and a hard disk drive (HDD), which are semiconductor memories.

The storage unit 160 stores user information 162, history information 164, presented-feature history information 166, and presented feature information 168.

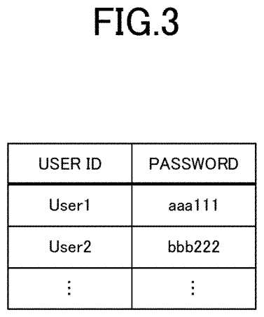

The user information 162 is referred to by the image forming apparatus 10 to authenticate a user of the image forming apparatus 10. For example, the user information 162 includes user IDs (for example, “User1”) for identifying users and passwords (for example, “aaa111”) that are information used for authenticating the users, as illustrated in FIG. 3. The information used for authenticating the users may be any information that can authenticate users besides passwords, for example, information for biometric authentication, such as fingerprint patterns or iris patterns.

The history information 164 includes a history of features used in the image forming apparatus 10 (history information). In this embodiment, the content executed by the image forming apparatus 10 under the instruction of the user is managed in units of jobs. The image forming apparatus 10 stores information on the jobs executed under the instruction of the user as job information.

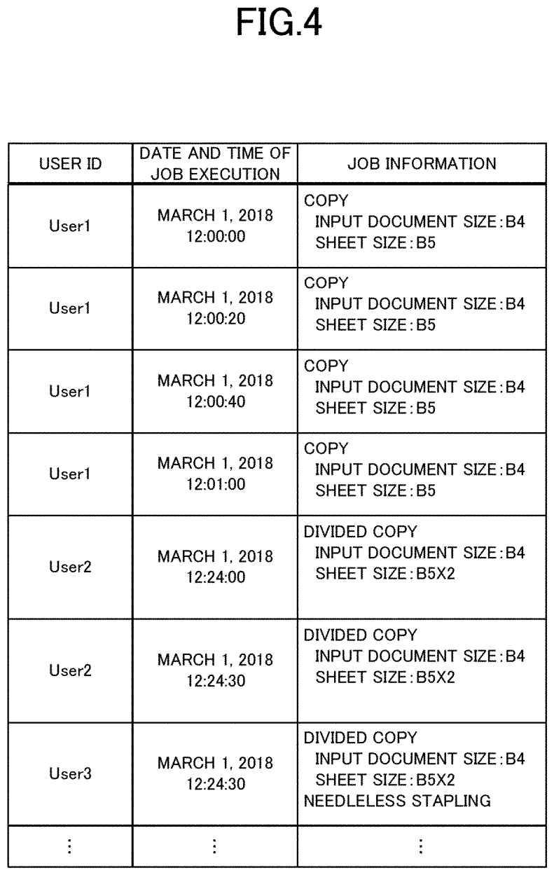

For example, with reference to FIG. 4, the history information 164 includes user IDs (for example, “User1”) for identifying users, dates and times of job execution (for example, “Mar. 1, 2018, 12:00:00”), and job information (for example, “copy; input document size, B4; sheet size, B5”).

The job information includes the features used by the users and information on input/output during use of the features. Here, the term “features” refers to processes executed under instructions by users, including output data processing, recording media processing, and processes executed in the image forming apparatus 10. For example, the image forming apparatus 10 may have a feature “divided copying” corresponding to a process in which image data input to the document reader 112 is divided into left and right halves and output in order. The image forming apparatus 10 may further have a feature “needleless stapling” corresponding to a process in which a plurality of recording sheets are pressure-bonded to form depressions in the recording sheets that function as fasteners. The developer of the image forming apparatus 10 determines which features are to be provided in the image forming apparatus 10 on the basis of the processes executable by the image forming apparatus 10. The job information may include information (output conditions) such as numerical values and attribute values (for example, magnification of an enlargement/reduction feature) set by the user during use of the feature.

The input/output information includes information regarding the image data input to the input unit 110 (for example, document size) and information regarding the recording media output from the image forming apparatus 10 (for example, sheet size).

A plurality of features may be executed during one job. For example, the “divided copy” feature and the “needleless stapling” feature can be executed to, for example, bind two recording sheets having image data divided into left and right halves, with needleless staples. In such a case, the plurality of features are stored as the job information of the history information.

In specific, in the job information “copy; input document size, B4; sheet size, B5”, “copy”, which is a process name, corresponds to a feature, and “input document size, B4; sheet size, B5”, which is information regarding the recording medium, corresponds to input/output information.

The presented-feature history information 166 corresponds the history of features that have been presented. The term “present” in this embodiment refers to an operation carried out by the image forming apparatus 10 to notify a user about a feature of the image forming apparatus 10. The term “presented feature” refers to a feature presented by the image forming apparatus 10. A feature is presented by displaying text explaining the feature on the display unit 150. Alternatively, a feature may be presented by displaying still or moving images describing the feature on the display unit 150 or by outputting sound under the control of the control unit 100.

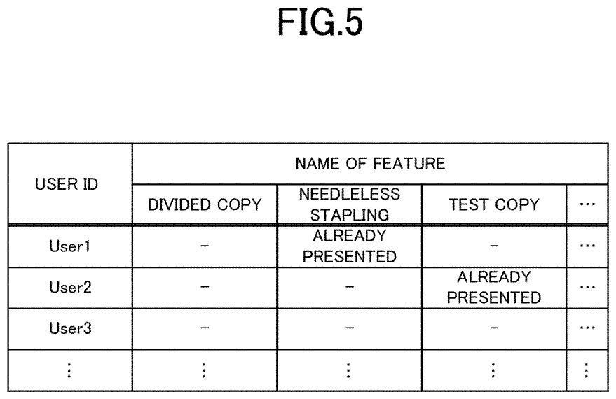

With reference to FIG. 5, the presented-feature history information 166 includes, for example, user IDs for identifying users (for example, “User1”) and names of the features that have been presented (for example, “divided copy”).

The parameter “already presented” is assigned to features that have already been presented to each user, to indicate which feature has been presented to which user. For example, in the example illustrated in FIG. 5, the feature “needleless stapling” has already been presented to the user corresponding to the user ID “User1.”

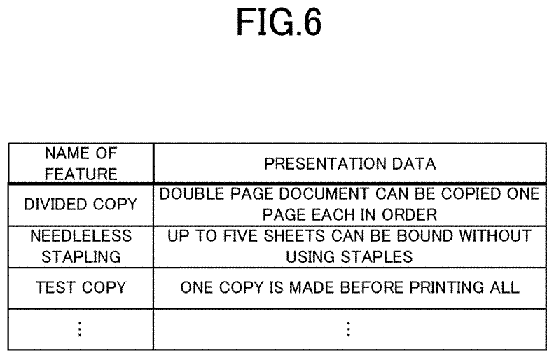

The presented feature information 168 is information used to present features. With reference to FIG. 6, the presented feature information 168 includes, for example, names of features for identifying the features (for example, “divided copy”) and presentation data corresponding to the text presented to the user when the features are presented (for example, “A double page document can be copied one page each in order”). In this embodiment, the presentation data is a character string. Alternatively, the presentation data may image data, moving image data, or audio data.

The communication unit 180 is a functional unit for establishing communication between the image forming apparatus 10 and another apparatus. For example, the communication unit 180 may be a network interface card (NIC) used in a wired or wireless LAN or a communication module connectable to a 3G or LTE line.

### 1.2 Process Flow

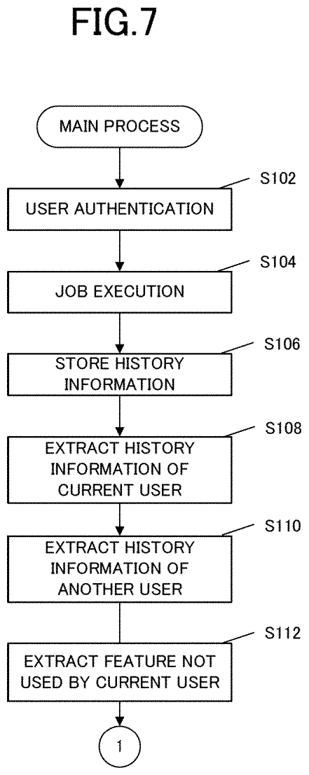

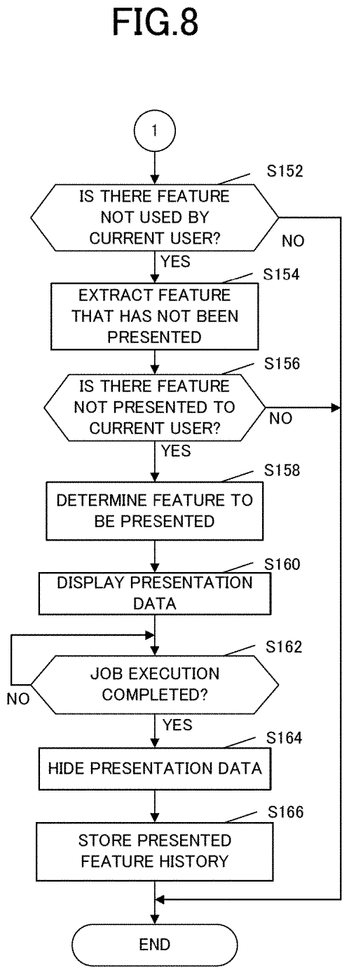

The main process executed by the image forming apparatus 10 will now be explained with reference to FIGS. 7 and 8. First, the control unit 100 of the image forming apparatus 10 authenticates the user who is to use the image forming apparatus 10 (step S102). The control unit 100 controls the display unit 150, for example, to display a screen for inputting a user ID and a password. In response to the user inputting an input of the user ID and password via the operating unit 140, the control unit 100 determines whether the input information is included in the user information 162. If the information input by the user is included in the user information 162, the control unit 100 authenticates the user. A user authenticated by the image forming apparatus 10 is referred to as “current user” in this embodiment.

The control unit 100 then executes a job in accordance with the feature instructed to be executed by the current user (step S104). The control unit 100 stores the job information on the feature executed under the instruction of the current user, the inputted image data, and the outputted recording medium, together with the user ID of the current user who executed the job and the date and time of the execution of the job, in the history information 164 (step S106).

The control unit 100 then extracts, from the history information 164, the history information (first history information) matching the user ID of the current user as history information of the current user (step S108). Furthermore, the control unit 100 extracts, from the history information 164, the history information (second history information) not matching the user ID of the current user as history information of a user other than the current user (step S110).

The first history information is a portion of the history information 164 regarding the current user. The second history information is a portion of the history information 164 different from the first history information. The first history information may be the history information of the current user or some or all of the history information stored in the image forming apparatus 10 operated by the current user. In this embodiment, the first history information is the history information of the current user, and the second history information is the history information of a user other than the current user.

The control unit 100 then extracts a feature not used by the current user (step S112). In specific, the control unit 100 extracts a feature that is included in the history information of another user extracted in step S110 but not in the history information of the current user extracted in step S108, to be a feature not used by the current user.

With reference to FIG. 8, the control unit 100 then determines whether at least one feature has been extracted in step S112 (step S152). If no features have extracted in step S152 (NO in step S152), the main process ends. If at least one feature has been extracted in step S152 (YES in step S152), the control unit 100 retrieves the presented-feature history information 166 and extracts a feature that has not been presented to the current user (step S154).

The control unit 100 then compares the feature extracted in step S112 with the feature extracted in step S154 and determines whether or not there is a feature that has not been presented among the features not used by the current user (step S156). Note that even if there is a feature that is not used by the current user, if the image forming apparatus 10 has already presented the feature (NO in step S156), the main process ends.

If there is a feature that has not been presented among the features not used by the current user (YES in step S156), the control unit 100 determines the feature to be present among the features that have not been presented (step S158). For the feature to be presented, the control unit 100 may refer to the history information of another user and determine all features that have been used by users other than the current user as the features to be presented or may determine a high-use feature that has been frequently used by the users other than the current user. The term “high-use feature” refers to a feature that has been used many times by users other than the current user, i.e., a feature frequently used by users other than the current user. In specific, the term “high-use feature(s)” may refer to the feature that has been most used by users other than the current user or the top few features most used by users other than the current user (for example, the top three features most used by users other than the current user). Beside defining a high-use feature on the basis of use frequency, it may be defined based on the number of users, and the term “high-use feature” may refer to the feature that has been used by the largest number of users. When a plurality of features are presumed to be high-use features, the high-use feature may be defined as the feature that has been used most or the feature that has been used by the most users.

When the feature to be presented is determined on the basis of the number of times the feature has been used, a feature that has been used more than a predetermined number of times (for example, 10 times) by users other than the current user may be determined to be a high-use feature. In this way, the control unit 100 can extract a feature that has a predetermined usage record in step S158. That is, when only a small amount of history information is stored the history information 164, the control unit 100 can be prevented from extracting a feature that has only been used several times by users other than the current user as a high-use feature. When the feature to be presented is determined on the basis of the number of users, the feature used by more than a predetermined number of users (for example, 10 users) may be determined to be the high-use feature. The predetermined number of users may be, for example, a number based on percentage, such as 10% of the users the user information 162.

The control unit 100 then retrieves the presentation data of the feature extracted in step S158 from the presented feature information 168 and controls the display unit 150 to display the retrieved presentation data (step S160). If two or more features are extracted in step S158, the control unit 100 retrieves the presentation data corresponding to each feature from the presented feature information 168 and controls the display unit 150 to switch the displayed presentation data at predetermined time intervals (for example, every 10 seconds) or in accordance with a user operation. If the presentation data is audio data, the feature is presented by playing the audio data.

When the execution of the job is completed (YES in step S162), the control unit 100 performs control to turn off the display of the presentation data displayed in step S160 (step S164). In this way, the image forming apparatus 10 can present a feature to the current user while the current user is waiting for the image data to be read and printed.

The control unit 100 then retrieves the presented-feature history information 166 and stores the parameter “already presented” in the presented-feature history information 166 in correlation with the user ID of the current user and the feature name displayed in step S160 (step S166). In this way, a feature that has been presented will not be displayed again.

Beside the steps described above, the order of the step may be changed or one or more steps may be omitted within a range without contradiction. Example methods of processing for the main process of the image forming apparatus 10, besides that described above, will be listed below.

In a first process, step S160 is executed subsequent to step S152. In this way, the image forming apparatus 10 can present to the current user a feature that has not been used by the current user but used by users other than the current user or a feature that is infrequently used by users other than the current user.

In a second process, step S158 is executed subsequent to step S152. In this way, the image forming apparatus 10 can determine a feature to be presented, from features that have not been used by the current user but have been used by users other than the current user.

In a third process, steps S154 to S156 are interchanged with step S158. In other words, a feature that has not been presented is determined after the feature to be presented is determined. This can increase the processing rate in the case where many features are to be presented.

In a fourth process, steps S160 to S164 are executed at a timing other than during execution of a job. For example, the control unit 100 controls the display unit 150 to display the name of a feature and its presentation data before execution of a job, that is, while the current user is selecting a feature or the like. In this way, the image forming apparatus 10 can present a feature to the current user before the current user instructs the execution of a job.

In the case where the image forming apparatus 10 is used by many users, the control unit 100 may specify a second user who has instructed the execution of jobs similar to the jobs of which the execution has been instructed by the current user and define the history information of the second user to be second history information. A second user who has instructed the execution of jobs similar to the jobs of which the execution has been instructed by the current user is determined by the control unit 100, for example, by extracting a second user different from the current user and comparing the job information of the current user and the job information of the second user in the history information 164. The control unit 100 determines the second user to be a user who has instructed the execution of jobs similar to the jobs of which the execution has been instructed by the current user when not less than a predetermined number of matches are found in the features and input/output information items in the job information of the current user and the job information of the second user. The control unit 100 may use machine learning or any other scheme to calculate the similarity between the job information of the current user and the job information of a user other than the current user. A user having a similarity exceeding a predetermined level is determined to be the second user who has instructed the execution of jobs similar to the jobs of which the execution has been instructed by the current user. The image forming apparatus 10 presents a feature to the current user on the basis of the usage history of the user who has instructed the execution of jobs similar to the jobs of which the execution has been instructed by the current user. As a result, the image forming apparatus 10 can present more useful information to the current user.

### 1.3 Operation Example

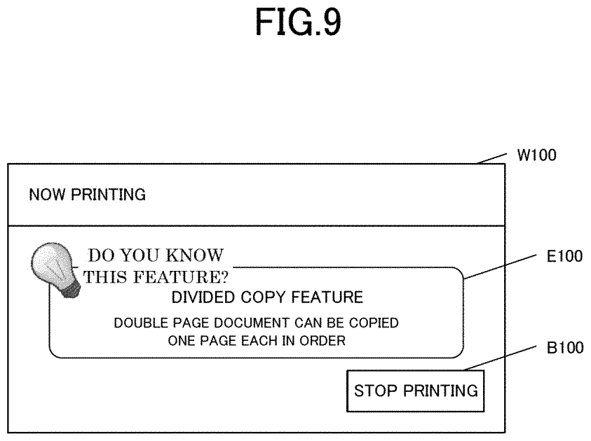

An example image displayed on the display unit 150 according to this embodiment will now be described with reference to FIG. 9. FIG. 9 is an example of a display screen W100 appearing on the display unit 150 when the image forming apparatus 10 is executing a job. The display screen W100 includes a display area E100 in which a feature is displayed for presentation, and a button B100 for receiving an instruction to cancel printing.

In the example illustrated in FIG. 9, the divided copy feature, which has been determined to be a feature that has not been used by and presented to the current user and has been used by users other the current user, is being presented by displaying the name of the feature and the presentation data corresponding to the feature in the form of text in the display area E100. The current user can view the display screen W100 and learn the name and content of the feature.

### 1.4 Advantageous Effects

According to this embodiment, a feature that has not been used by the current user but has been used by users other than the current user can be presented to the current user. In the case where a single image forming apparatus 10 is shared among users, such as in this embodiment, the jobs to be executed under the instruction of the users are presumably similar. Thus, it is possible to refer to the history information of other users who have instructed the execution of similar jobs and present useful information to the current user. In particular, a feature that has a generally low usage rate but can be used effectively under certain environments can be presented on the basis the history information of users other than the current user.

### 2. Second Embodiment

The second embodiment will now be described. In the second embodiment, history information is acquired from another image forming apparatus connected via a network. For example, when only a small amount of history information is stored in the image forming apparatus used by the current user, the image forming apparatus used by the current user acquires history information from another image forming apparatus connected via the network. In this way, a feature can be presented to the current user on the basis of an increased amount of history information.

### 2.1 Overall Structure

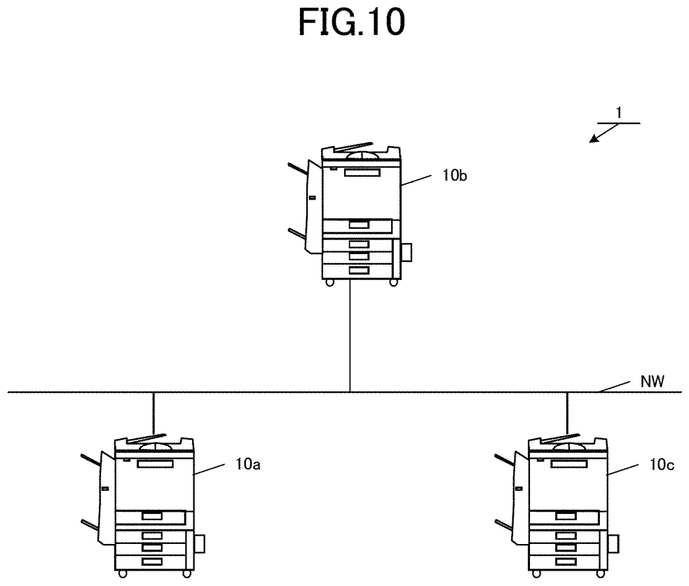

The overall structure according to this embodiment will now be described. FIG. 10 illustrates an overall configuration of an image forming system 1. The image forming system 1 includes three image forming apparatuses 10 (image forming apparatuses 10a, 10b, and 10c) according to the first embodiment, connected via a network NW. The network NW is, for example, a local area network (LAN).

The functional configuration of each image forming apparatus 10 is the same as that described in the first embodiment. Note that each of the image forming apparatuses 10 according this embodiment can send a request for history information (history information request) to the other image forming apparatuses 10 connected to the network NW via its communication unit 180 and receive history information sent from the other image forming apparatuses 10 via its communication unit 180. In response to a history-information request received via the communication unit 180, the image forming apparatus 10 sends the content of the history information 164 to the other image forming apparatus 10 that has sent the history information request.

For example, the current user uses the image forming apparatus 10a in the image forming system 1 illustrated in FIG. 10. At this time, the image forming apparatus 10a sends a history information request to the image forming apparatuses 10b and 10c connected to the network NW. The image forming apparatuses 10b and 10c having received the history information request send the stored history information 164 to the image forming apparatus 10a. In this way, the image forming apparatus 10a can acquire the history information of the image forming apparatuses 10b and 10c. The image forming apparatus 10a presents a feature to the current user on the basis of the history information of the image forming apparatuses 10b and 10c in addition to the history information of the image forming apparatus 10a.

### 2.2 Process Flow

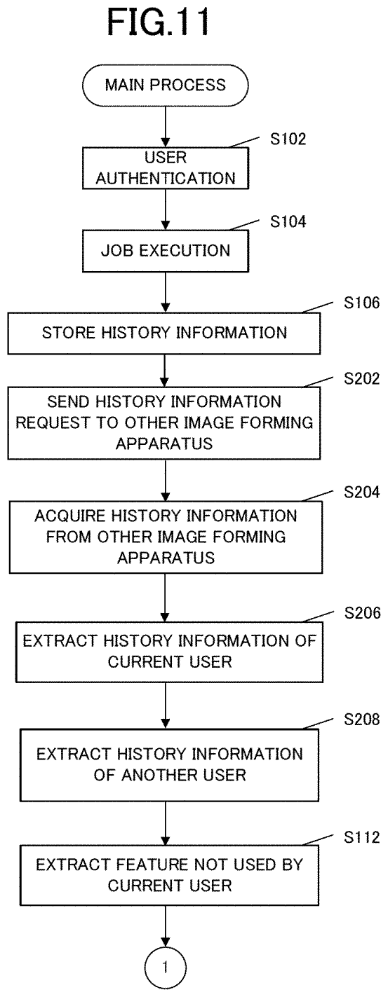

The process flow according to this embodiment will now be explained. In this embodiment, the process of the first embodiment illustrated in FIG. 7 is replaced with the process illustrated in FIG. 11. Same steps are denoted by same reference signs, and descriptions thereof are omitted.

In this embodiment, the control unit 100 of the image forming apparatus 10 stores history information (step S106) and then sends a history information request to other image forming apparatuses 10 connected to the network NW via its communication unit 180 (step S202). The control unit 100 acquires history information from other image forming apparatuses 10 via the communication unit 180 (step S204).

The control unit 100 then extracts history information of the current user (first history information) from the history information 164 and the history information acquired in step S204 (step S206). Subsequently, the control unit 100 extracts history information of a user other than the current user (second history information) from the history information 164 and the history information acquired in step S204 (step S208).

The image forming apparatus 10 then executes step S112 and the subsequent steps to present a feature that has not been used by the current user and has not been presented to the current user.

### 2.3 Advantageous Effects

According to this embodiment, an image forming apparatus 10 can present a feature on the basis of history information acquired from other image forming apparatuses 10 even when only an insufficient amount of history information is available, for example, such as in a case in where a new image forming apparatus 10 is installed and sufficient history information is not yet stored.

When image forming apparatuses 10 are installed in different office departments or office floors, the features used in each image forming apparatus 10 may differ. Even in such a case, a feature can be presented on the basis of the history information of the image forming apparatuses 10 installed in different office departments or office floors. The feature to be presented can be appropriately determined because even when the image forming apparatuses 10 are installed in different office departments or office floors, the environment in which the image forming apparatuses 10 are installed is presumably similar.

Furthermore, a feature can be presented even when the current user uses a plurality of image forming apparatuses 10 in a network because the feature is presented on the basis of the history information stored in the image forming apparatuses 10 connected to the network.

### 3. Third Embodiment

The third embodiment will now be described. In the third embodiment, history information is received from a history-information managing apparatus that manages history information, unlike in the second embodiment.

### 3.1 Overall Structure

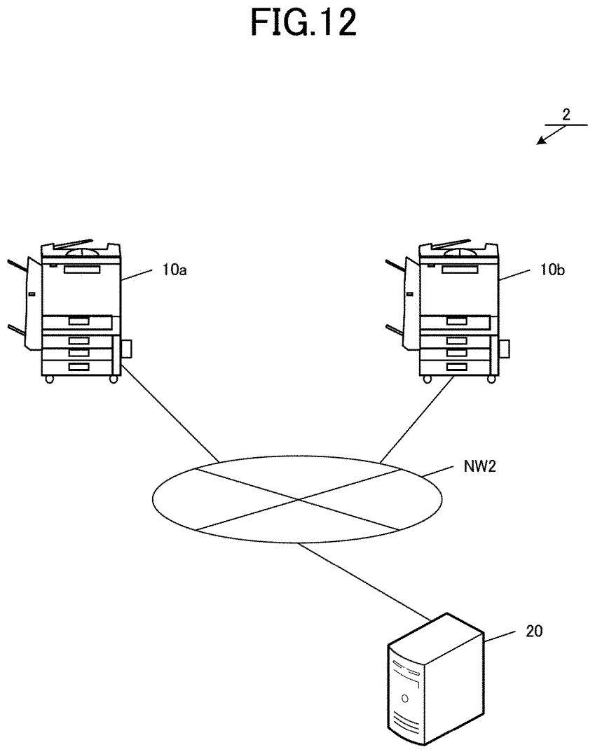

The overall structure according to this embodiment will now be described. FIG. 12 illustrates the overall configuration of an image forming system 2. The image forming system 2 includes two image forming apparatuses 10 (image forming apparatuses 10a and 10b) according to the first embodiment and a history-information managing apparatus 20, connected via a network NW2. The network NW2 is, for example, the Internet.

The history-information managing apparatus 20 manages history information of the image forming apparatuses 10 connected to the network NW2 and has a feature for sending history information in response to a request from any of the image forming apparatuses 10. Alternatively, the history-information managing apparatus 20 may be an apparatus managing only history information or a center machine comprehensively managing the image forming apparatuses 10 on the network. The history-information managing apparatus 20 may be connected to the same network as the image forming apparatuses 10.

### 3.2 Functional Configuration of History-Information Managing Apparatus

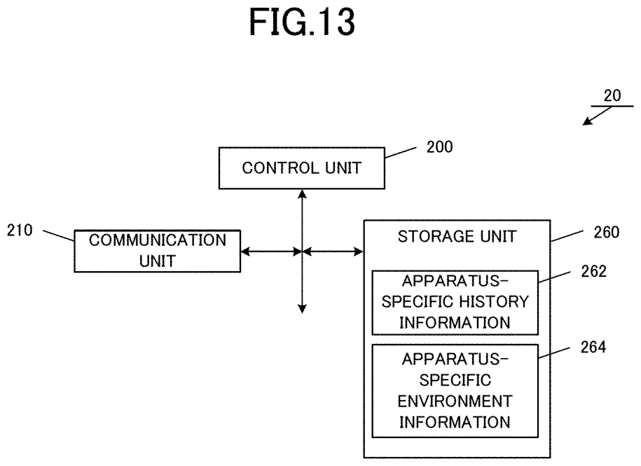

The functional configuration of the history-information managing apparatus 20 will now be described with reference to FIG. 13. The history-information managing apparatus 20 includes a control unit 200, a communication unit 210, and a storage unit 260.

The control unit 200 is a functional unit for comprehensively controlling the history-information managing apparatus 20. The control unit 200 establishes various features by retrieving and executing various programs and includes, for example, at least one computing device (such as a CPU).

The communication unit 210 is a functional unit for establishing communication between the history-information managing apparatus 20 and another apparatus. For example, the communication unit 210 may be an NIC used in a wired or wireless LAN or a communication module connectable to 3G or LTE line.

The storage unit 260 is a functional unit for storing various programs and datasets necessary for operation of the history-information managing apparatus 20. The storage unit 260 includes, for example, an SSD and an HDD, which are semiconductor memories.

In particular, the storage unit 260 stores apparatus-specific history information 262 and apparatus-specific environment information 264.

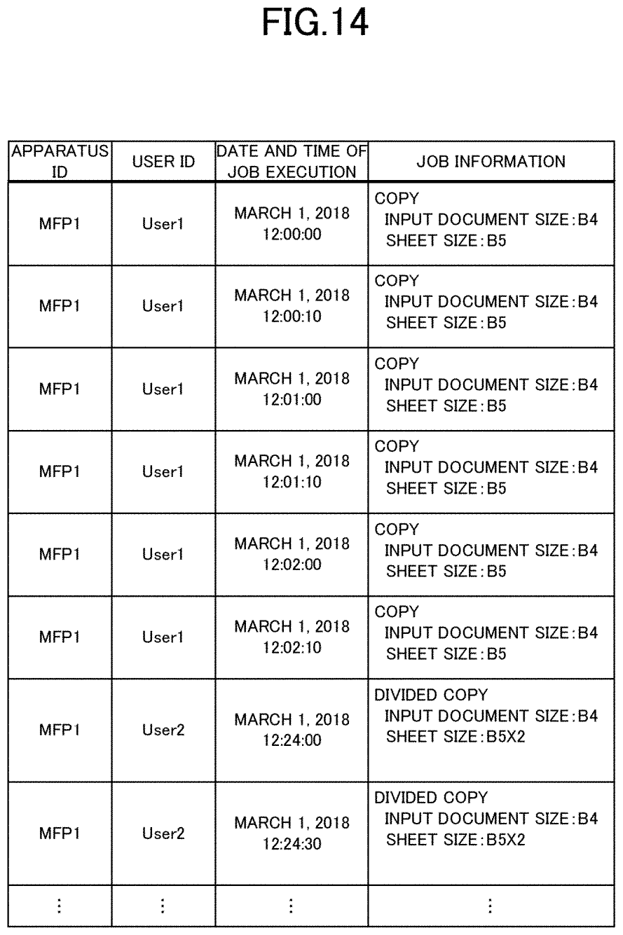

The apparatus-specific history information 262 includes history information received from the image forming apparatuses 10. With reference to FIG. 14, the apparatus-specific history information 262 includes apparatus IDs (for example, “MFP1”) for identifying the apparatuses 10, user IDs (for example, “User1”) for identifying users, the dates and times of job execution (for example, Mar. 1, 2018, 12:00:00”), and job information (for example, “copy; input document size, B4; sheet size, B5”).

The apparatus-specific environment information 264 includes environment information on the environment in which the image forming apparatuses 10 are installed. The environment information indicates the environment in which an image forming apparatus 10 is used. Environment information includes information on the image forming apparatuses 10, such as model names and options provided in the image forming apparatuses 10, and information regarding the use site of the image forming apparatuses 10, such as the number of users of the image forming apparatus and the number of image forming apparatuses 10 connected to the same network.

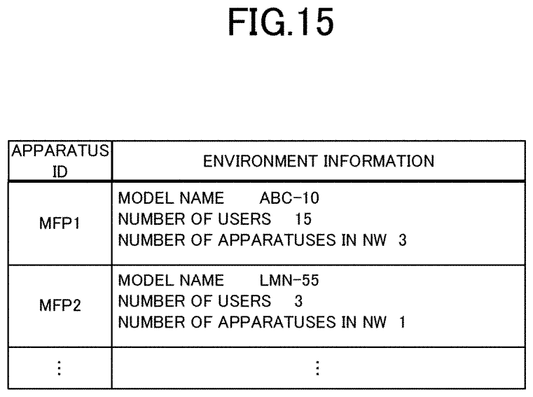

With reference to FIG. 15, the apparatus-specific environment information 264 includes apparatus IDs (for example, “MFP1”) for identifying image forming apparatuses 10 and environment information (for example, “model name, ABC-10; number of users, 15; number of apparatuses in the network NW, 3”).

### 3.3 Process Flow

### 3.3.1 Process Executed by History-Information Managing Apparatus

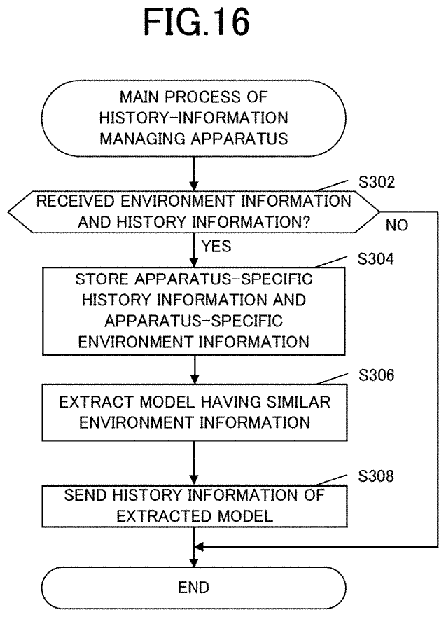

The process executed by the history-information managing apparatus 20 will now be described with reference to FIG. 16. First, the control unit 200 of the history-information managing apparatus 20 determines whether environment information and history information have been sent from a first image forming apparatus 10 connected to the network NW2 via the communication unit 210 (step S302). If environment information and history information are received (YES in step S302), the control unit 200 stores the received history information together with the apparatus ID of the first image forming apparatus 10 in the apparatus-specific history information 262. The control unit 200 also stores the received environment information together with the apparatus ID of the first image forming apparatus 10 in the apparatus-specific environment information 264 (step S304).

The control unit 200 then selects an image forming apparatus 10 other than the first image forming apparatus 10 among the image forming apparatuses 10 linked to environment information similar to the environment information received in step S302 in the apparatus-specific environment information 264 (step S306). For example, the control unit 200 selects an image forming apparatus 10 having the same model name as that of the first image forming apparatus 10. Alternatively, the control unit 200 may select an image forming apparatus 10 having the same number of users as the first image forming apparatus 10 or having a predetermined number of users, or an image forming apparatus 10 connected to the same number of image forming apparatuses 10 as the first image forming apparatus 10 or connected to a predetermined number of image forming apparatuses 10 in the same network. Alternatively, the control unit 200 may select one image forming apparatus 10 linked to the environment information most similar to the received environment information or a plurality of image forming apparatuses 10 linked to environment information having predetermined number of similarities with the received environment information.

The control unit 200 then extracts history information from the apparatus-specific history information 262 on the basis of the apparatus ID of the image forming apparatus 10 selected in step S306 and sends the extracted history information to the first image forming apparatus 10 that sent the environment information and the history information (step S308).

Through the process described above, the history-information managing apparatus 20 can update the apparatus-specific history information 262 on the basis of the history information sent from the first image forming apparatus 10. In addition, the history-information managing apparatus 20 can send history information of another image forming apparatus 10 installed in an environment similar to that of the first image forming apparatus 10, to the first image forming apparatus 10.

### 3.3.2 Process Executed by Image Forming Apparatus

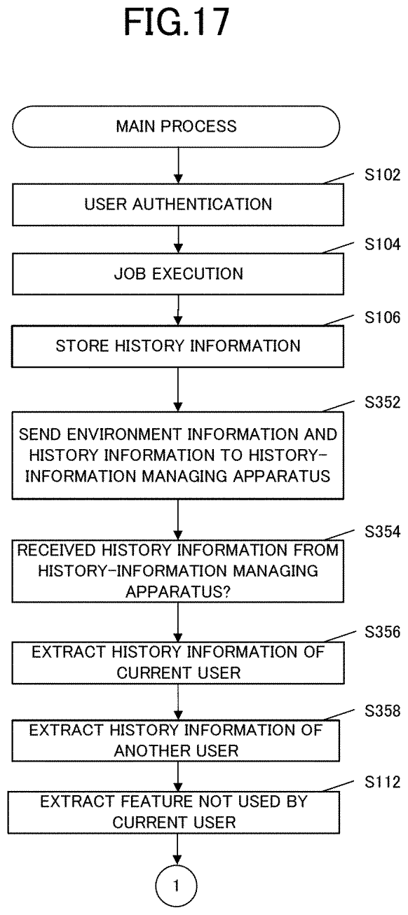

The process flow according to this embodiment will now be explained. In this embodiment, the process of the first embodiment illustrated in FIG. 7 is replaced with the process illustrated in FIG. 17. Same steps are denoted by same reference signs, and descriptions thereof are omitted.

In this embodiment, a first image forming apparatus 10 executes a job and stores history information (step S106). Then the control unit 100 of the first image forming apparatus 10 sends environment information and history information to the history-information managing apparatus 20 via a communication unit 180 (step S352). The environment information may be preliminarily stored in the first image forming apparatus 10 or may be generated by the first image forming apparatus 10 in accordance with the use status.

The control unit 100 then acquires history information from the history-information managing apparatus 20 via the communication unit 180 (step S354). Through the process executed by the history-information managing apparatus 20, the first image forming apparatus 10 acquires history information of a second image forming apparatus 10 linked to environment information similar to the environment information of the first image forming apparatus 10.

The control unit 100 then extracts history information of the current user of the first image forming apparatus 10 (first history information) from the history information 164 and the history information acquired in step S354 (step S356). The control unit 100 then extracts history information of a user other than the current user (second history information) from the history information 164 and the history information acquired in step S354 (step S358).

The image forming apparatus 10 performs step S112 and the subsequent steps to present a feature that has not been used by and not been presented to the current user.

According to this embodiment, a feature can be presented even after replacement of the image forming apparatus. That is, when there is no content in the history information 164, such as when a previous image forming apparatus 10 is replaced with another image forming apparatus 10, the history information of the previous image forming apparatus 10 is acquired from the history-information managing apparatus 20 and stored in the history information 164 of the newly installed image forming apparatus 10.

In this way, the newly installed image forming apparatus 10 can use the usage history of the previous image forming apparatus 10. In this way, the feature of the previous image forming apparatus 10 that have been used by the user will not be presented on the newly installed image forming apparatus 10.

The feature of the newly installed image forming apparatus 10 to be presented may be extracted from features that have not been provided in the previous image forming apparatus 10. For example, in step S112, the control unit 100 extracts a feature that has been frequently used by a user other than the current user, among features that have not been provided in the previous image forming apparatus 10. In this case, the usage rate of the extracted feature is low compared to that of features provided in the previous image forming apparatus 10 because the extracted feature is a newly available feature. Even with such a low usage rate, however, the control unit 100 can extract the newly available feature and display the feature on the display unit. In this way, the image forming apparatus 10 can preferentially present a newly available feature of the image forming apparatus 10 that is newly installed.

### 3.4 Advantageous Effects

According to this embodiment, even when only a small amount of history information is stored in the image forming apparatus operated by the current user, a feature can be presented on the basis of history information of other image forming apparatuses. The history information stored in the history-information managing apparatus 20 may correspond to image forming apparatuses used in various different environments. Even in such a case, the image forming apparatus operated by the current user can acquire history information on the basis of embodiment information. In this way, a feature can be presented on the basis of history information of an image forming apparatus in an environment similar to that of the environment of the image forming apparatus operated by the current user.

Furthermore, a feature can be presented even after the image forming apparatus 10 is replaced with another image forming apparatus 10 because the history information of the previous image forming apparatus 10 is stored in the history-information managing apparatus 20 separate from the image forming apparatus 10.

### 4. Fourth Embodiment

The fourth embodiment will now be described. In the fourth embodiment, a feature is presented without authentication of the user by the image forming apparatus. When the image forming apparatus 10 does not authenticate the user, history information acquired during a predetermined period is used in place of the history of the current user.

For example, jobs executed during a predetermined period (for example, 30 minutes) may be provided as history information of the current user (first history information). Since the history information 164 includes the dates and times of job execution, the jobs executed during a predetermined period from the current time can be stored as the history information of the current user.

Alternatively, in the case where the image forming apparatus 10 has a power saving mode, the jobs executed during a period starting immediately after switching from the power saving mode to a normal mode and ending immediately after switching back to the power saving mode may be provided as history information of the current user (first history information).

The content of the history information 164 excluding the first history information is then defined as second history information. In this way, a feature that has not been used by the current user but has been used by other users of the image forming apparatus 10 can be presented to the current user.

When the history information of a second image forming apparatus 10 is to be used like in the second and third embodiments, all pieces of history information stored in a first image forming apparatus 10 operated by the current user may be defined as the history information of the current user (first history information). All pieces of history information stored in the second image forming apparatuses 10 may be defined as second history information. In such as case, the first image forming apparatus 10 operated by the current user presents a feature that has not been used in the first image forming apparatus 10 but has been used in the second image forming apparatuses 10.

According to this embodiment described above, a feature can be presented to a user without user authentication.

### 5. Fifth Embodiment

The fifth embodiment will now be described. The fifth embodiment presents a feature on the basis of history information during execution of a predetermined job, the feature corresponding to (related to) the predetermined job.

### 5.1 Functional Configuration

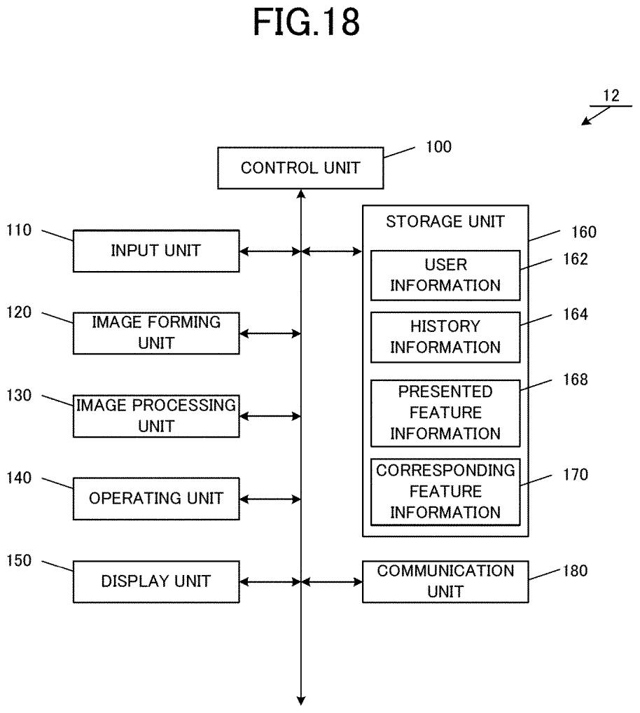

The functional configuration of an image forming apparatus 12 of this embodiment is illustrated in FIG. 18. In this embodiment, the configuration of the first embodiment illustrated in FIG. 2 is replaced with the configuration illustrated in FIG. 18. Same processes are denoted by same reference signs, and descriptions thereof are omitted. Unlike the image forming apparatus 10 described above, the image forming apparatus 12 according to this embodiment includes a storage unit 160 storing corresponding feature information 170 but not storing presented-feature history information 166.

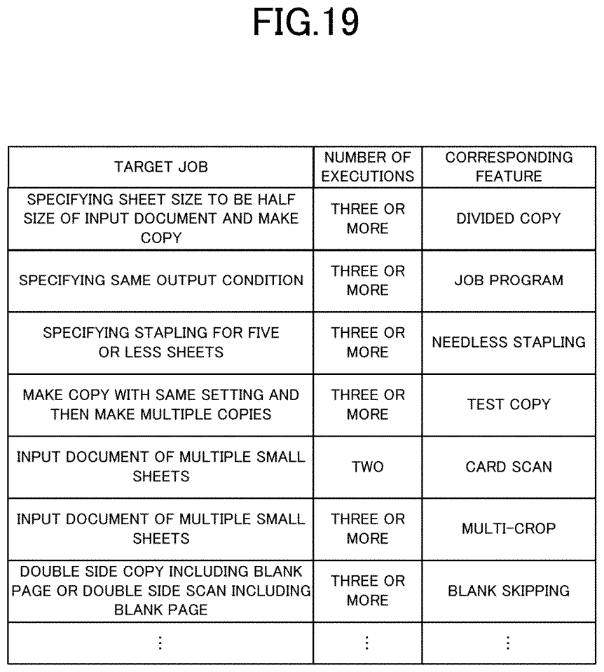

The corresponding feature information 170 correlates features and job executed by the user on the basis of the history information stored in the image forming apparatus 12. With reference to FIG. 19, the corresponding feature information 170 includes predetermined jobs or target jobs (for example, “specifying the sheet size to be half the size of the document”), the number of executions of the target jobs (for example, “three or more times”) before presenting corresponding features, and corresponding features that are features corresponding to the target jobs (for example, “divided copy”).

The corresponding feature information 170 may include a feature that can achieve a result that are the same of or similar to the results achieved by a job executed by a user, as a corresponding feature. Alternatively, the corresponding feature may be a feature that can be executed after the previous feature is executed and completed or a feature that can enhance the convenience of the user. Alternatively, the corresponding features may be a feature corresponding to or related to input/output information or information (output conditions) established by the user.

Alternatively, the corresponding features may be a new feature associated with a conventional feature. The number of executions of the target job should be set to at least one such that, when a user instructs the execution of a conventional job, the corresponding new feature can be presented.

When an old-model image forming apparatus is replaced with a new-model image forming apparatus, the new-model image forming apparatus usually has features not provided in the old-model image forming apparatus. Some new-model image forming apparatuses can use the settings of old-model image forming apparatuses. In the case where such a new-model image forming apparatus is installed, the new-model image forming apparatus can also use the job history stored in the old-model image forming apparatus. Thus, in some cases, the user of the new-model image forming apparatus continues to use only the features that have been provided in the old-model image forming apparatus and does not use the new features provided in the new-model image forming apparatus. According to this embodiment, when it can be determined on the basis of the job information in the history information that a job determined to correspond to (relating to) a new feature of the new-model image forming apparatus on the basis of the type of the job is being executed, the new feature of the new-model image forming apparatus can be presented. In this way, a new feature can be presented to the current user even when other users have not used the new feature.

### 5.2 Process Flow

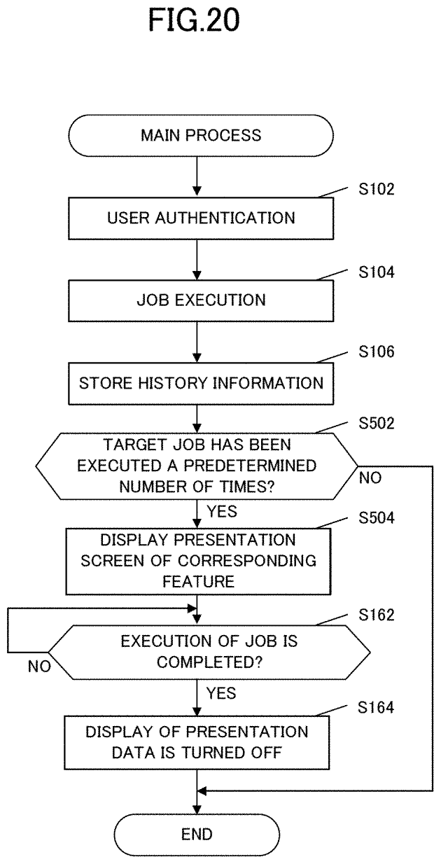

The process executed by the image forming apparatus 12 according to this embodiment is illustrated in FIG. 20. In this embodiment, the processes of the first embodiment illustrated in FIGS. 7 and 8 are replaced with the process illustrated in FIG. 20. Same processes are denoted by same reference signs, and descriptions thereof are omitted.

After storing history information (step S106), the control unit 100 retrieves the corresponding feature information 170 and determines whether the history information 164 of the current user includes job information of the target job indicating that the job has been executed the number of times specified by the number of executions of the target jobs before presenting corresponding features (step S502).

For example, with reference to FIG. 19, if the history information 164 stores job information, as the input/output information, indicating that a job of specifying a sheet size to be half the size of the input document and copying the input document on a sheet having the specified size has been performed three or more times, the control unit 100 determines that the result of step S502 is an affirmative result.

If the result of step S502 is an affirmative result, the control unit 100 retrieves a feature corresponding to the job executed under the instruction of the user from the corresponding feature information 170. The control unit 100 also retrieves presentation data on the retrieved feature from the presented feature information 168 and controls the display unit 150 to display the presentation data (step S504).

### 5.3 Advantageous Effects

According to the embodiment described above, a feature corresponding to a job executed under the instruction of the user can be presented. A feature that is likely to be used by the user can be presented because the feature is extracted on the basis of history information.

### 6. Modifications

The present invention is not limited to the embodiments described above, and various modifications can be made. That is, an embodiment obtained by combining technical means appropriately modified without departing from the scope of the present invention is also included in the technical scope of the present invention.

Although the above-described embodiments have portions described separately for convenience of explanation, it is needless to say that they may be implemented in combination within the technically possible range. For example, the first embodiment and the fifth embodiment may be executed in combination. In this way, features used by users other than the current user can be presented together with features corresponding to the job executed under the instruction of the current user.

Furthermore, the first embodiment, the second embodiment, and the third embodiment may be executed in combination. In such a case, the feature required by users is likely to be clear because jobs are often executed for similar purposes in similar use environments. Thus, a comparison is made the history information of the image forming apparatus being used by the user, the history information of the image forming apparatuses on the same network, and the history information managed by the history-information managing apparatus are compared with the history information of the user in this priority order. A comparison with history information with low priority is made when a reasonable result is not expected to be obtained through comparison with the history information of the user, such as when the number items in history information is smaller than a certain number.

The program operating on each apparatus in the embodiments is a program for controlling the CPU or the like (i.e., a program for operating a computer) to provide the functions according to the embodiments described above. The information handled in such an apparatus is temporarily stored in a temporary storage device (for example, RAM) when being processed. Then, the information is stored in a storage device such as a read only memory (ROM) or an HDD and, when necessary, is read, modified or written by the CPU.

The recording medium for storing the program may be any of a semiconductor medium (for example, a ROM or a non-volatile memory card), an optical recording medium/magneto-optical recording medium (for example, a digital versatile disc (DVD) or a magnetooptical (MO) disc), a mini disc (MD), a compact disc (CD), or a Blu-ray (registered trademark) disc), and a magnetic recording medium (for example, a magnetic tape or a flexible disc). By executing the loaded program, not only the functions of the above-described embodiments are realized. Moreover, by processing in cooperation with the operating system or another application program based on the instructions of the program, the features of the present invention may be realized.

For market distribution, the program can be stored in a portable recording medium and transmitted to a server computer connected via a network such as the Internet. In this case, the storage device of the server computer is obviously included in the present invention.

What is claimed is:

1. An image forming apparatus comprising:
a display unit;
a history-information storage unit that stores history information indicating a history of features that have been used in the image forming apparatus;
a feature extracting unit that extracts, from first history information corresponding to history information of a current user operating the image forming apparatus and second history information different from the first history information, a feature included in the second history information and not included in the first history information; and
a display control unit that controls the display unit to display the extracted feature.

2. The image forming apparatus according to claim 1, further comprising a user authentication unit that authenticates a user, wherein
the current user is a user authenticated by the user authentication unit.

3. The image forming apparatus according to claim 2, wherein
the feature extracting unit extracts a feature included in the second history information, not included in the first history information, and frequently used by a user other than the current user.

4. The image forming apparatus according to claim 1, wherein
the feature extracting unit extracts a feature included in the second history information, not included in the first history information, and determined to be frequently used based on the second history information.

5. The image forming apparatus according to claim 1, further comprising a presented-feature history-information storage unit that stores features that have been displayed by the display control unit, wherein
the feature extracting unit extracts a feature included in the second history information, not included in the first history information, and not stored in the presented-feature history-information storage unit.

6. The image forming apparatus according to claim 1, further comprising a history-information acquiring unit that acquires, from another image forming apparatus, the history information stored in the other image forming apparatus, wherein
the feature extracting unit extracts first history information of the current user and second history information different from the first history information, from the history information that is stored in the history-information storage unit and the history information that is acquired by the history-information acquiring unit and stored in the other image forming apparatus, and the feature extracting unit extracts a feature included in the second history information and not included in the first history information.

7. An image forming system comprising:
a plurality of image forming apparatuses; and
a history-information managing apparatus that manages history information indicating a history of features that have been used in the image forming apparatuses,
the history-information managing apparatus including a history-information managing unit that correlates and manages environment information indicating an environment in which the image forming apparatuses are used and history information of the image forming apparatuses, the environment information and the history information being acquired from the image forming apparatuses,
each of the image forming apparatuses including:
a display unit;
a history-information storage unit that stores history information indicating a history of features that have been used in the image forming apparatus;
a history-information acquiring unit that acquires, from the apparatus, history information correlated with environment information substantially identical to the environment information of the image forming apparatus;
a feature extracting unit that extracts, from first history information corresponding to history information of a current user operating the image forming apparatus and second history information acquired by the history-information acquiring unit, a feature included in the second history information and not included in the first history information; and
a display control unit that controls the display unit to display the extracted feature.

8. The image forming system according to claim 7, wherein
the environment information includes at least one of the number of users, the number of image forming apparatuses connected to the same network, an option provided in each of the image forming apparatuses, and a model name of each of the image forming apparatuses.

9. A method of controlling display of an image forming apparatus including a display unit, the method comprising:
storing history information indicating a history of features that have been used in the image forming apparatus;
extracting, from first history information corresponding to history information of a current user operating the image forming apparatus and second history information different from the first history information, a feature included in the second history information and not included in the first history information; and
controlling the display unit to display the extracted feature.
